(19) United States
(12) Patent Application Publication
(10) Pub. No.: US 2012/0024985 A1
(43) Pub. Date: Feb. 2, 2012

(54) INTEGRATED FUEL NOZZLE AND INLET FLOW CONDITIONER AND RELATED METHOD

(75) Inventors: Thomas Edward JOHNSON, Greer, SC (US); John Brandon MACMILLAN, Liberty, SC (US)

(73) Assignee: GENERAL ELECTRIC COMPANY, Schenectady, NY (US)

(21) Appl. No.: 12/848,620

(22) Filed: Aug. 2, 2010

(51) Int. Cl. B05B 1/26; B21D 51/16

(52) U.S. Cl. 239/518; 29/890.12

(57) ABSTRACT

A nozzle center body includes a unitary, one-piece, elongated tubular member having a forward end formed with a radially outwardly extending mounting flange; an aft end formed with a plurality of radially outwardly extending swirler vanes; and, an intermediate region, located axially between the forward and aft ends, formed with an inlet flow conditioner including an annular plate provided with plural, circumferentially-spaced flow openings therein. A related method of forming the nozzle center body by casting is also disclosed.

### BACKGROUND OF THE INVENTION

This invention relates to gas turbine combustor technology and, more specifically, to the manufacture of an inlet flow conditioner integrated with a gas turbine combustor fuel nozzle.

Inlet flow conditioners are used to remove both radial and circumferential variations in air flowing into a fuel nozzle. More specifically, the inlet flow conditioner reduces the large velocity and pressure gradients entering the fuel nozzle so that the air and gas fuel will mix in a uniform and predictable manner. If the air entering the fuel nozzle has substantial circumferential and radial flow variations, achieving the required precise fuel and air ratios becomes problematic.

Not all combustor fuel nozzles utilize inlet flow conditioners. Many nozzles simply use an inlet Bell mouth configuration; however, when trying to achieve a very uniform inlet air stream in a combustor configuration where the fuel nozzles are densely-packed, a more complicated inlet flow conditioner arrangement becomes necessary. The typical inlet flow conditioner consists of a cylindrical tube containing many small round or oval holes, and several bell-mouth-shaped flow directors. These tightly-toleranced sheet metal components, which are very costly, create the potential for a large amount of variation in the air flow into the nozzle. A pressure drop is set up across the small holes in an effort to obtain a uniform flow of air into the downstream swirler. When a dimensional tolerance is specified on a small hole, however, the percentage of area variation is large when compared to the same tolerance applied to a large hole.

Accordingly, it would be desirable to utilize a simpler, less-costly manufacturing technique for a fuel nozzle inlet flow conditioner that is also configured to yield less variation in the flow of air through the conditioner.

### SUMMARY OF THE INVENTION

In accordance with an exemplary but nonlimiting embodiment, the invention provides a nozzle center body comprising a unitary, one-piece elongated tubular member having a forward end formed with a radially outwardly extending mounting flange; an aft end formed with a plurality of radially outwardly extending swirler vanes; and, an intermediate region, located axially between the forward and aft ends, formed with an inlet flow conditioner including an annular plate provided with plural, circumferentially-spaced flow openings therein.

In another exemplary but nonlimiting embodiment, there is provided an inlet flow conditioner for a gas turbine nozzle comprising an annular plate having a center opening adapted to receive a nozzle body; the annular plate comprising radially inner and radially outer rings connected by plural radially-extending struts, the radially inner and radially outer rings and the radially-extending struts defining plural air flow apertures, each having a peripheral edge shaped to provide predetermined air flow characteristics.

In still another exemplary but nonlimiting embodiment, there is provided a method of forming a nozzle body comprising: casting a one-piece, unitary nozzle center body including an elongated tubular member having a forward end formed with a radially outwardly extending mounting flange; an aft end formed with a swirler comprised of a plurality of radially outwardly extending vanes; and, an intermediate region, located axially between the forward and aft ends, formed with an inlet flow conditioner including an annular plate provided with plural, circumferentially-spaced flow openings therein.

The invention will now be described in greater detail in connection with the drawing figures identified below.

### BRIEF DESCRIPTION OF THE DRAWINGS

FIG. 1 is a partial schematic cross section of a fuel nozzle fitted with an inlet flow conditioner;

FIG. 2 is a perspective view of an inlet flow conditioner integrated with a fuel nozzle in accordance with an exemplary but nonlimiting embodiment of the invention;

FIG. 3 is a cross section through the fuel nozzle shown in FIG. 2 but with an outer support tube added;

FIG. 4 is a partial end view illustrating an exemplary flow opening in an inlet flow conditioner in accordance with an exemplary aspect of the invention;

FIG. 5 is a perspective view of an inlet flow conditioner in accordance with another exemplary but nonlimiting embodiment of the invention;

FIG. 6 is a partial cross section taken along the line 6-6 of FIG. 5;

FIG. 7 is a partial cross section of an inlet flow conditioner in accordance with another exemplary embodiment of the invention; and

FIG. 8 is a partial cross section of an inlet flow conditioner in accordance with still another exemplary embodiment of the invention.

### DETAILED DESCRIPTION OF THE INVENTION

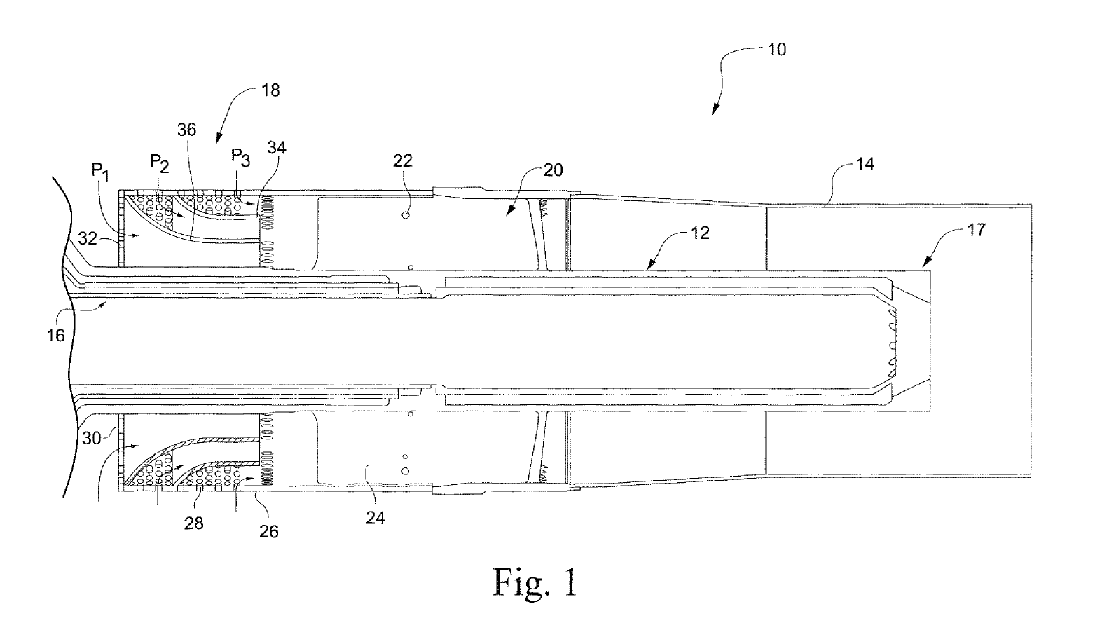

FIG. 1 illustrates a gas turbine combustor nozzle 10 including a radially inner center body 12 and a radially outer support tube 14. A mounting flange (not shown) is located at the forward end (i.e., to the left in FIG. 1) of the nozzle and facilitates mounting the nozzle to the combustor. Fuel and air are supplied to the combustion chamber through plural passages indicated generally at 16 within the center body, exiting at the center body aft or outlet end 17 (i.e., to the right in FIG. 1). An inlet flow conditioner 18 is secured to the outer nozzle support tube 14 at a location upstream of a swirler 20 where fuel is injected through apertures 22 in the hollow vanes 24 of the swirler into air that has passed through the conditioner 18. The air and fuel mix within the annulus formed by the outer support tube 14 and the center body 12 and then burn once they enter the combustion chamber in a manner well understood by those skilled in the art.

The inlet flow conditioner 18 is comprised of an outer sheet-metal tube or sleeve 26 provided with a plurality of apertures 28 about the circumference thereof, and a forward wall 30 also provided with an array of apertures 32. Within the tube or sleeve 26, there are two, concentrically-arranged, bell-mouth-shaped bodies 34, 36 which establish three separate paths for air entering the nozzle, indicated at P1, P2 and P3. While the size and pattern of the various holes or apertures may be designed to establish a uniform flow of air past the swirler 20, the manufacturing issues related to the formation and assembly of the flow conditioner 18 makes flow uniformity problematic. The resulting fabricated flow conditioner is very expensive due to its labor-intensive process which involves punching hundreds of holes, several forming and turning operations, complicated-splitting operations, welding operations and the inspections associated with these steps.

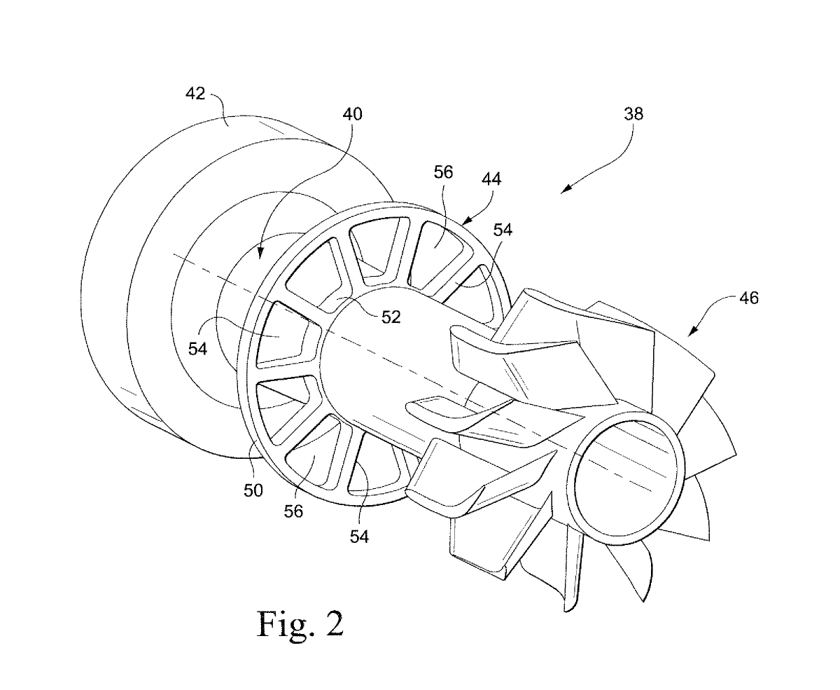

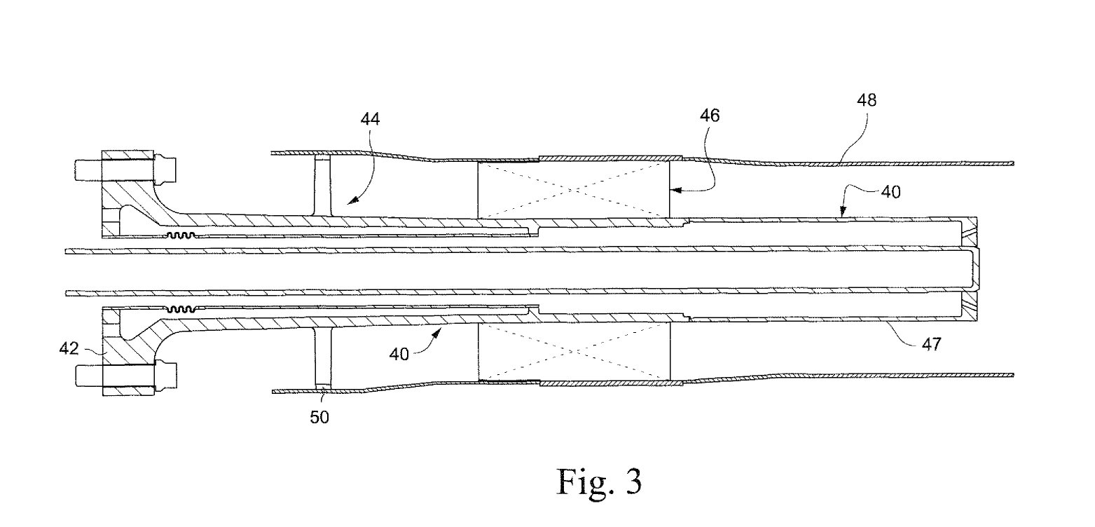

FIGS. 2 and 3 illustrate a fuel nozzle with an integrated inlet flow conditioner in accordance with an exemplary but nonlimiting embodiment of the invention. Specifically, the nozzle 38 includes, generally, a fuel nozzle body 40 provided at a forward end with a fuel supply/mounting flange 42. Downstream of the flange 42, there is an inlet flow conditioner 44 and, downstream of the flow conditioner is a swirler 46, adjacent or proximate the aft or outlet end portion 47 welded to the nozzle body (seen only in FIG. 3). An outer support tube or sleeve 48 (see FIG. 3) surrounds the nozzle body 40 and is engaged by the radially outer tip surfaces of the swirler 46 and the radially outer annular ring 50 of the inlet flow conditioner 44. It will be appreciated that because the invention here relates to the flow conditioner configuration and to the manner in which the flow conditioner is formed, no further discussion is needed with respect to the remaining details of the nozzle body/nozzle construction.

The inlet flow conditioner 44 is shown in FIGS. 2 and 3 as a substantially planar annular plate comprised of the outer annular ring 50 already mentioned, and an inner annular ring 52 (FIG. 2) connected by a series of radially-extending, circumferentially-spaced spokes or struts 54 which create an array of openings 56 about the circumference of the flow conditioner.

A new method of manufacturing the inlet flow conditioner 44 in accordance with this invention takes advantage of the fact that the swirler 46, located downstream of the inlet flow conditioner 44, is made using an investment casting process. In accordance with the exemplary but nonlimiting embodiment disclosed herein, the inlet flow conditioner 44 may be manufactured with the other nozzle features, e.g., the swirler 46, by forming each feature in the wax state and then joining them together (by e.g., wax welding or gluing) to form a single wax core. In this way, the entire component, including the center body 40, mounting flange 42, inlet flow conditioner 44 and swirler 46 may be cast as a single, unitary (one-piece) component. To produce the inlet flow conditioner feature concurrently with the other nozzle features in the wax state is a very inexpensive process, yet highly repeatable, which leads to highly-consistent and repeatable air flow results. Investment casting, while preferred, is not required and the individual components 42, 44 and 46 may be formed, for example, by machining, and then joined to the nozzle body 40 using a welding or brazing operation. If machined, the inner annular ring 52 would define a center opening for receiving the nozzle body 40.

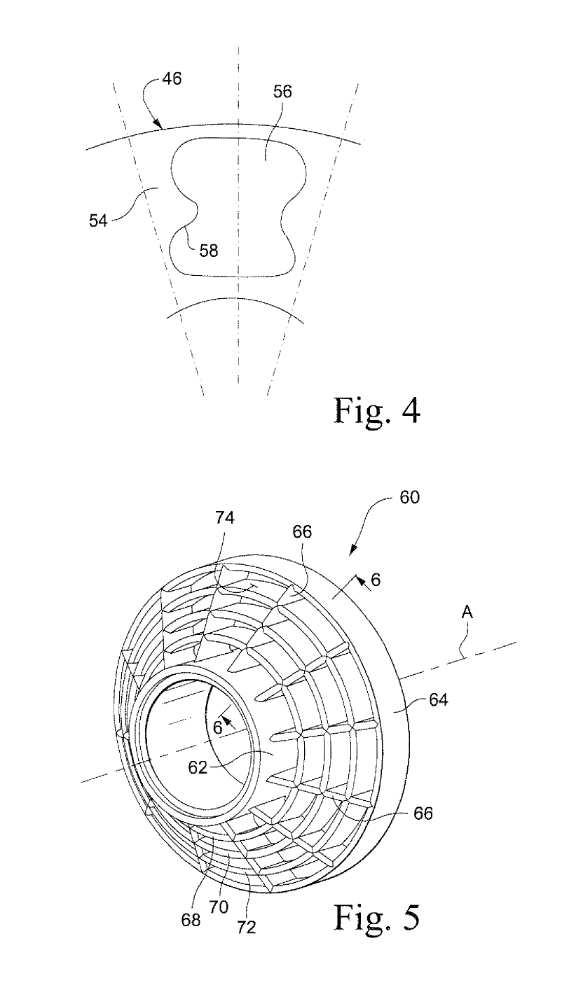

It is also possible with investment casting (or machining) to vary the sizes and shapes of the openings 56 around the perimeter of the inlet flow conditioner 44. With reference to FIG. 4, for example, the openings 56 as defined by inner and outer rings 50, 52 and radial struts 54, may have an edge contoured to provide the desired airflow characteristics. FIG. 4 merely illustrates that fairly complex profiles, as defined by an aperture peripheral edge 58, can be easily cast in place at little comparative expense, providing, for example, differential flow characteristics in both radial and circumferential direction.

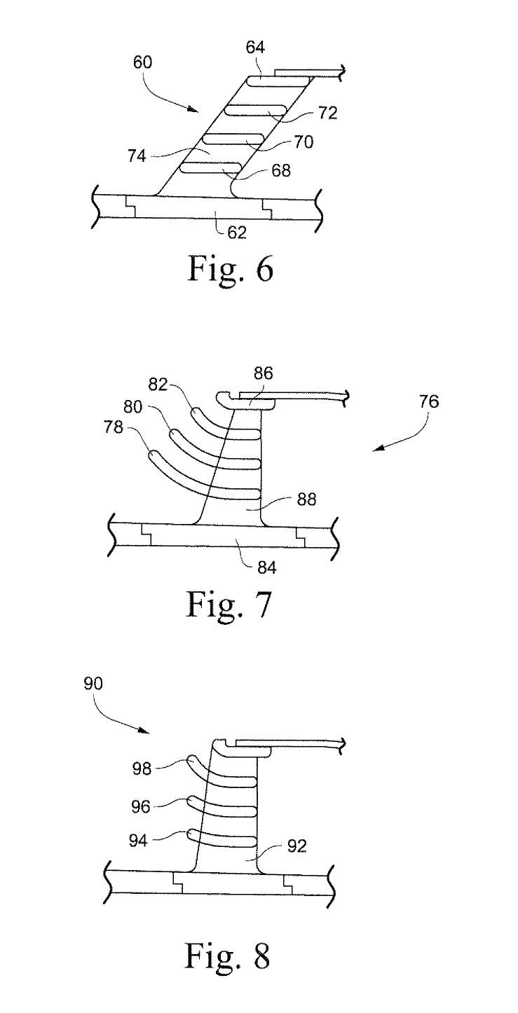

FIGS. 5 and 6 illustrate a non-planar inlet flow conditioner 60 in accordance with another exemplary but nonlimiting embodiment. Here, the inner and outer rings 62, 64 are axially offset so that the radial struts 66 extend at an acute angle to the axis A of the nozzle body. A series of concentrically-arranged, axially offset rings 68, 70 and 72 supported by the struts 66, create an array of flow openings 74 that, in addition to being non co-planar, increase in size from their radially inner ends to their radially outer ends, thus creating a unique air flow pattern upstream of the swirler.

FIG. 7 illustrates a generally similar inlet flow conditioner 76 but in this variant, the series of concentric rings 78, 80 and 82 are curved to match the inflow of air and extend in an upstream direction beyond the radially inner and outer rings 84, 86 and beyond the radial struts 88.

FIG. 8 illustrates yet another exemplary embodiment of a flow conditioner 90 where the radial struts 92 are more upright, but still slightly sloped, and where the concentric rings 94, 96 and 98 have a shorter length in the upstream direction, and differential degrees of curvature.

It will thus be appreciated that the inlet flow conditioner as described herein may take on any of several suitable configurations that are amenable to a simplified manufacturing process, and that provide the ability to tune the openings in the conditioner to achieve air flow characteristics that, in turn, produce the desired uniformity in the fuel/air mixture in the nozzle.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A nozzle center body comprising:
A unitary, one-piece elongated tubular member having a forward end formed with a radially outwardly extending mounting flange; an aft end formed with a plurality of radially outwardly extending swirler vanes; and, an intermediate region, located axially between said forward and aft ends, formed with an inlet flow conditioner including an annular plate provided with plural, circumferentially-spaced flow openings therein.

2. The nozzle center body of claim 1 wherein said annular plate is comprised of radially inner and radially outer rings connected by a plurality of radially extending, circumferentially-spaced struts defining said plural, circumferentially-spaced flow openings.

3. The nozzle center body of claim 2 wherein said radially inner and radially outer rings are substantially coplanar.

4. The nozzle center body of claim 2 wherein said radially inner and radially outer rings are axially offset from each other.

5. The nozzle center body of claim 2 wherein said plural, circumferentially-spaced flow openings have peripheral edges contoured to provide desired flow characteristics for air flowing through said inlet flow conditioner.

6. The nozzle center body of claim 2 including substantially concentric intermediate rings at radially-spaced locations between said inner and outer rings to thereby provide additional circumferentially-spaced flow openings.

7. The nozzle center body of claim 6 wherein at least forward ends of said substantially concentric intermediate rings are axially offset from each other.

8. The nozzle center body of claim 7 wherein said forward ends of said substantially concentric intermediate rings are curved in a radial outward direction.

9. The nozzle center body of claim 2 wherein said forward ends extend axially upstream beyond edges of said circumferentially-spaced struts.

10. An inlet flow conditioner for a gas turbine nozzle comprising:
an annular plate having a center opening adapted to receive a nozzle body; said annular plate comprising radially inner and radially outer rings connected by plural radially-extending struts, said radially inner and radially outer rings and said radially-extending struts defining plural air flow apertures, each having a peripheral edge shaped to provide predetermined air flow characteristics.

11. The inlet flow conditioner of claim 10 wherein said radially inner and radially outer rings are substantially coplanar.

12. The inlet flow conditioner of claim 10 wherein said radially inner and radially outer rings are axially offset from each other.

13. The inlet flow conditioner of claim 10 wherein said forward ends of said substantially concentric intermediate rings are curved in a radial outward direction.

14. The inlet flow conditioner of claim 10 wherein said forward ends extend axially upstream beyond edges of said circumferentially-spaced struts.

15. A method of forming a nozzle body comprising: casting a one-piece, unitary nozzle center body including an elongated tubular member having a forward end formed with a radially outwardly extending mounting flange; an aft end formed with a swirler comprised of a plurality of radially outwardly extending vanes; and an intermediate region, located axially between said forward and aft ends, formed with an inlet flow conditioner including an annular plate provided with plural, circumferentially-spaced flow openings therein.

16. The method of forming a nozzle body according to claim 15 wherein said plural, circumferentially-spaced flow openings are each formed to include peripheral edges contoured to provide, in use, desired flow characteristics for air flowing through said inlet flow conditioner.

17. The method of forming a nozzle body according to claim 15 wherein said mounting flange, said swirler and said inlet flow conditioner are first provided as discrete wax components subsequently joined to form a single wax core for casting.

18. The method of claim 15 wherein said radially inner and radially outer rings are substantially coplanar.

19. The method of claim 15 wherein said radially inner and radially outer rings are axially offset from each other.

20. The method of claim 15 wherein, during casting, substantially concentric intermediate rings are formed at radially-spaced locations between said inner and outer rings to thereby provide additional circumferentially-spaced flow openings.
